(19) United States
(12) Patent Application Publication
(10) Pub. No.: US 2017/0347084 A1
(43) Pub. Date: Nov. 30, 2017

(54) VIRTUAL REALITY PANORAMIC VIDEO SYSTEM USING SCALABLE VIDEO CODING LAYERS

(71) Applicant: Intel Corporation, Santa Clara, CA (US)

(72) Inventor: Jill M. Boyce, Portland, OR (US)

(73) Assignee: Intel Corporation, Santa Clara, CA (US)

(21) Appl. No.: 15/258,807

(22) Filed: Sep. 7, 2016

Related U.S. Application Data
(60) Provisional application No. 62/342,570, filed on May 27, 2016.

(51) Int. Cl. H04N 13/00; H04N 19/159; H04N 19/105; H04N 19/30; H04N 13/04

(52) U.S. Cl. CPC H04N 13/0014; H04N 13/0048; H04N 13/0059; H04N 13/0051; H04N 19/105; H04N 13/004; H04N 19/30; H04N 19/159; H04N 13/044

(57) ABSTRACT

A virtual reality panoramic video system is described that uses scalable video coding layers. One example includes a buffer to receive a wide field of view video, a region extractor to extract regions from the wide field of view video, and a scalable multi-layer video encoder to encode the extracted regions as separate layers and to combine the layers to form an encoded video.

### CROSS-REFERENCE TO RELATED APPLICATION

The present application is a nonprovisional of prior U.S. Patent Application Ser. No. 62/342,570, filed May 27, 2016, entitled “VIRTUAL REALITY PANORAMIC VIDEO SYSTEM USING SCALABLE VIDEO CODING LAYERS,” by Jill M. Boyce, the priority of which is hereby claimed and the contents of which are hereby incorporated by reference herein.

### FIELD

The present application pertains to a panoramic video system suitable for virtual reality, inter alia, and, in particular to such a system with scalable video coding layers.

### BACKGROUND

Panoramic video playback systems using Virtual Reality (VR) head mounted displays are beginning to emerge for consumer use. In these systems, a much larger field of view is captured, encoded, and decoded than is actually viewed by a particular viewer at a given point in time. In these systems, very large panoramic video frames are formed, typically by stitching together the outputs of several video cameras. The video sequence is sometimes referred to as 360 video. These large panoramic video frames are encoded by video encoders at a high bitrate, and then a compressed video bitstream corresponding to the sequence of the very large panoramic video frames is sent to a viewer. At the viewer end, the bitstream containing the full panoramic compressed video frames is received and decoded, creating a representation of the entire panoramic field of view.

A smaller region-of-interest is selected for display. The selected region-of-interest is determined by actions of the viewer, such as by changing the position of the head mounted display, and can change very quickly. The viewer sees only the selected region of interest and the rest of the video frame is not used. As a result, the system can respond quickly to head movements. A similar approach is used with other image projection formats. The compressed bitstream may be equirectangular, equal area, spherical, cube map, or cylindrical.

### BRIEF DESCRIPTION OF THE DRAWING FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity.

FIG. 1 is a diagram of a video frame with a region of interest suitable for use with embodiments of the invention.

FIG. 2 is a block diagram of video capture, encoding, and presentation system according to an embodiment.

FIG. 3 is a diagram of a video frame with three regions of interest suitable for use with embodiments of the invention.

FIG. 4 is a diagram of a video frame with six regions of interest suitable for use with embodiments of the invention.

FIG. 5 is a block diagram of another video capture, encoding, and presentation system according to an embodiment.

FIG. 6 is an isometric view of a wearable device with IMU and display according to an embodiment.

FIG. 7 is a process flow diagram of capturing and encoding video according to an embodiment.

FIG. 8 is process flow diagram of receiving and decoding video according to an embodiment.

FIG. 9 is a block diagram of a computing device suitable for video capture, encoding and presentation according to an embodiment.

### DETAILED DESCRIPTION

Encoding, transmitting, and decoding a much larger field of view than is actually viewed wastes compute, network, and storage resources. As described herein, the resources necessary for panoramic video playback may be reduced. The proposed panoramic video codec system encodes panoramic video frames by forming regions, possibly overlapping, from the full resolution panoramic frames, and downsampling the full panoramic video frames, and coding the downsampled frames and full resolution regions as layers using a scalable video codec, such as the SHVC (Scalable HEVC) scalable video coding extension of HEVC (High Efficiency Video Codec). During playback, based on the region-of-interest selected for display, a subset of the layers corresponding to the full resolution region or regions containing the region-of-interest are decoded, along with the downsampled base layer, in a multi-layer SHVC decoder, to display the selected region-of-interest. The same approach may be used with other video frame types including equirectangular, equal area, spherical, cube map, and cylindrical video.

The present description presents techniques and structure in the context of SHVC which is a scalability extension of HEVC. HEVC is being developed by the ISO/IEC Moving Picture Experts Group and ITU-T Video Coding Experts Group (VCEG). These organizations are the International Organization for Standardization (ISO), the International Electrotechnical Commission (IEC) and the International Telecommunication Union Telecommunications Standard sector (ITU-T). However, other video coding and decoding systems also use layers that may depend on each other and may be selected or de-selected. The techniques described herein may be applied to any such system.

The video decoding resources needed for panoramic video viewing may be reduced by not requiring decoding of the full large panoramic video frames when only a small region-of-interest is to be viewed, as is required in existing systems, while enabling rapid changing of the selected region-of-interest for display. This leads to savings in area, power and memory bandwidth in the client device. Network bandwidth may also be reduced.

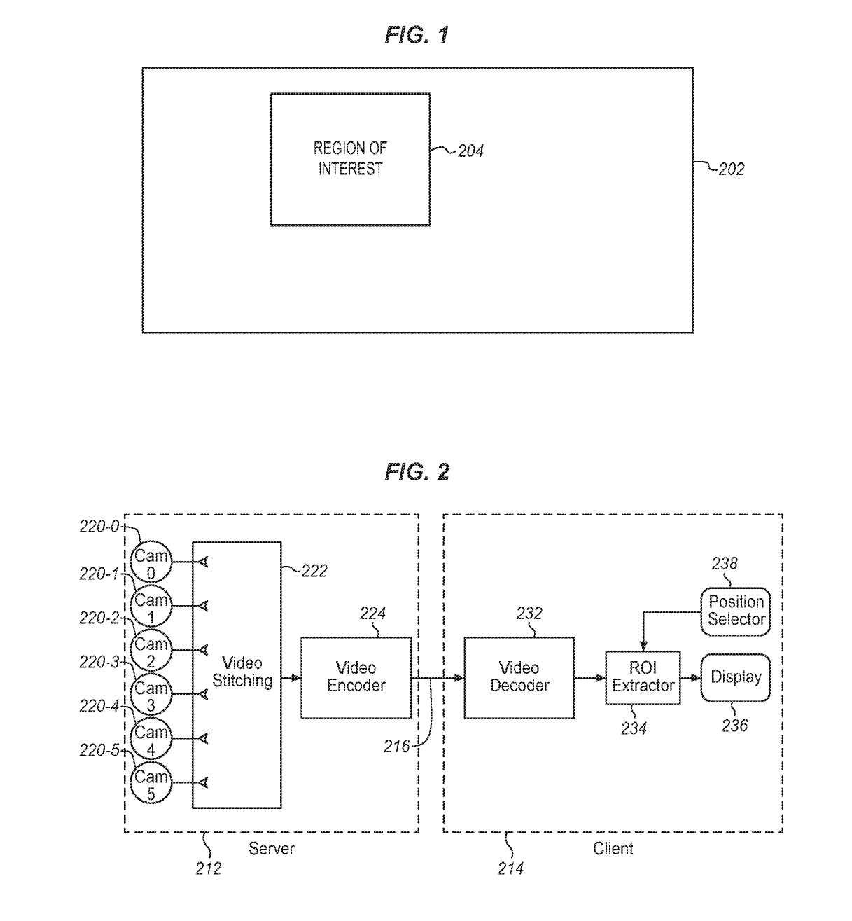

FIG. 1 is a diagram of a region of interest in context. It shows an example panoramic video frame 202 and a region of interest 204 within the video frame. The region of interest relates to the area currently being viewed and is much smaller than the total frame. The particular size relationship will depend on the implementation. A similar diagram pertains to equirectangular, equal area, spherical, cube map, and cylindrical frames. For a typical VR headset there are two such frames, one for each eye.

FIG. 2 is a block diagram of a panoramic video system. It has a server system 212 to generate video for use by the client and to send video to a client system 214 for consumption by the client. The video is sent through a link 216 which may be wired or wireless and which may be across a short or a long distance. At the server end, multiple cameras 220-0, 220-1, 220-2, 220-3, 220-4, 220-5 capture a large field of view, and those camera views are fed to a video stitching block 222 in which they are stitched together to form panoramic frames. These output panoramic frames are fed to a video encoder 224 in which they are encoded. The encoded video is then sent over a network or wired tether 216 to a client.

There may be storage, subscription, transmission, broadcast, or other distributions systems between the server and the client. The number and configuration of the cameras may be modified to suit different types of frames. In some cases, one or two cameras may be used to capture a distorted view that includes the entire view. The distorted view is then corrected at the client side or the server side.

At the client 214, the compressed panoramic frames are received from the link 216 at a video decoder 232 and then decoded. An instantaneous region-of-interest for the viewer is determined in a region of interest (ROI) extractor 234 which receives the decoded video. The ROI may be extracted based on a position selector 238 which may be based on the head mounted display position, motion sensors in the display, gesture control, user inputs or other devices. The region-of-interest extracted from the decoded panoramic frames, is sent to the display 236, e.g. the head-mounted display and displayed as a sequence of frames. In prior systems significant decoding resources are used in the video decoder to process the entire panoramic frame, even though only a small region is actually displayed.

The scalable video coding extension to the HEVC standard, called SHVC, enables coding of multiple layers of video independently. Higher layers may be coded at the same resolution as lower layers or may be at a higher resolution. Individual layers may be coded independently of other layers or may be coded dependently of lower layers, using inter-layer prediction for improved coding efficiency. The SHVC standard provides syntax to indicate dependencies between layers in a very flexible manner. For example, a coded video sequence can contain 3 layers, where layer 0 is the base layer, layer 1 depends on layer 0, and layer 2 depends on layer 0, but layer 2 does not depend on layer 1. The standard also provides syntax to indicate spatial offsets between an enhancement layer and its reference layer, so that they are not required to represent exactly the same region.

As described herein, to code the panoramic or other large scale video, the large panoramic video frames are downsampled, and the downsampled frames are coded as the base layer. For example, the downsampling ratio in each dimension could be ½, so that the downsampled frame is ¼ the size of the original panoramic frame. Other ratios may be used to suit transmission, storage, and processing constraints.

Regions are formed from the full resolution large panoramic frame, potentially overlapping, such that each pixel is assigned to at least one region. Each region is coded as a scalable enhancement layer, dependently coded on the base layer using inter-layer prediction with a scalable video codec, such as SHVC.

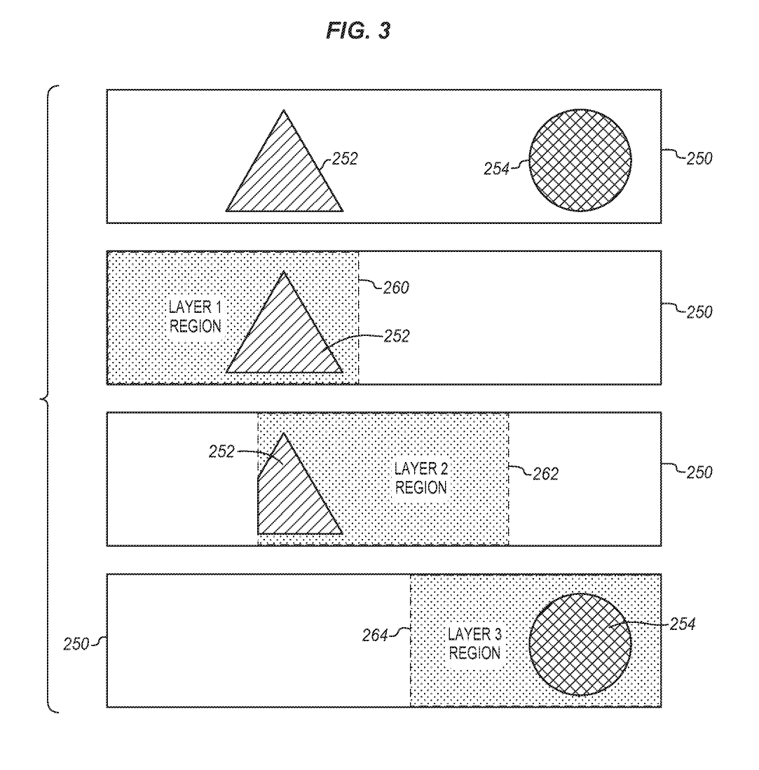

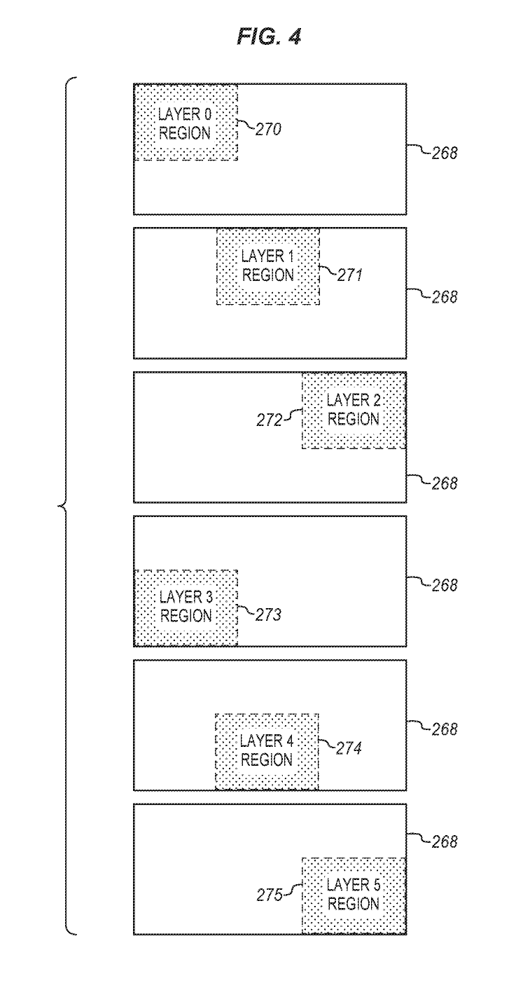

Examples of a panoramic frame's overlapping regions are shown in FIGS. 3 and 4. FIG. 3 is a diagram of a panoramic frame and of three overlapping regions into which the frame may be divided. The complete full frame 250 is shown at the top with no region indications. The full frame includes two objects, a triangle 252 on the left and a circle 254 on the right. A Layer 1 region 260 is shown in the second row is on the left side of the full frame 250. This left region includes the full triangle but none of the circle. A Layer 2 region 262 in the third row is in the center of the frame 250 overlaps Layer 1. It includes only part of the triangle and none of the circle. A Layer 3 region 264 in the fourth row overlaps the Layer 2 region and includes none of the triangle but the entire circle 254. FIG. 3 is provided as an example to show how multiple regions may overlap and how different objects may or may not be included in different regions.

FIG. 4 is a diagram of a panoramic frame split into six overlapping regions. The top three diagrams are similar to those of FIG. 3 with three overlapping regions indicated as Layer 0 270, Layer 1 271, and Layer 2 272. These three layers together cover the upper half of the full frame 268. The bottom three diagrams are similar and each show one of the next three layers, 273, 274, 275, which overlap horizontally in the same way as in FIG. 3 but which cover the bottom half of the frame. While each set of three horizontally overlap the next layer, the layers also overlap vertically. As a result, there is a center horizontal band of the frame in which the pixels are in one of the first three layers and also one of the second three layers. While these examples illustrate regions that are all the same size, that is not required, as regions of different sizes may be used. Each pixel of the panoramic frame may be contained within at least one region.

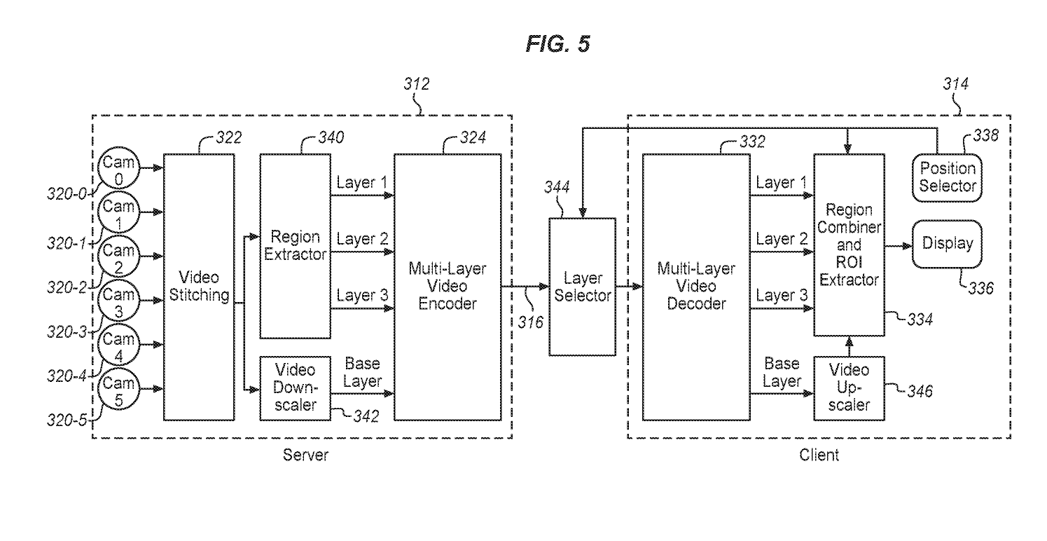

FIG. 5 shows a system block diagram for a panoramic video frame split into three overlapping regions and encoded as layers. The regions may be split as shown in FIG. 3 or in any other way. At a server end 312, multiple cameras 320-0, 320-1, 320-2, 320-3, 320-4, 320-5 capture videos as sequences of frames which are provided to a video stitching module 322 to be stitched together into panoramic video frames. The panoramic frames are sent to a video downscaler 342 where they are downsampled to form a base layer of the panoramic video. The base layer is sent to a scalable multi-layer video encoder 324 and coded as the base layer, which may be referred to as layer 0.

Multiple cameras are shown and described herein, however, a panoramic video may be captured using a single camera and an appropriate optical system to image the panoramic scene onto the single sensor. Different systems use differing numbers of cameras, however the benefits of dividing the frames into different regions does not depend on the number of cameras. In some embodiments, the regions are the same as a view from a single camera. In other embodiments, the regions are defined without consideration of the cameras. In addition, while the videos are described as panoramic this is not necessary. The captured video may show much less than a full panorama. It may have a limited vertical extent and a limited horizontal extent, depending on the intended use.

The panoramic frames are also sent from video stitching 322 to a region extractor 340. The extractor extracts full resolution regions from the frames. In this case there are three regions, but there may be more or less. The regions may be the same size or a different size. The three full resolution regions are sent to the multi-layer video encoder 324 and encoded as layers 1, 2 and 3 by the SHVC multi-layer video encoder. The regions are each encoded using inter-layer prediction from the base layer, and using reference layer offsets to indicate the relative position of the region with respect to the scaled base layer. There may also be additional layers (not shown) to provide enhanced details, additional information, or other features that may or may not use prediction from the base layer or offsets. There may also be additional layers corresponding to additional regions.

It is also possible to not use inter-layer prediction from the base layer, but to use a simulcast approach, where layers 1, 2, and 3 are each coded independently. SHVC provides syntax to indicate if inter-layer dependencies are used in a video sequence.

Including a low resolution version of the entire panoramic video frame (Layer 0), allows a user to immediately view any region-of-interest within the panoramic video frame at any time, albeit at a lower resolution. Using inter-layer prediction from the base layer improves coding efficiency as compared to coding the enhancement layer regions without a scalability extension. The use of a separate scalable layer for each region allows the regions to be individually decodable, and allows the regions to be overlapping. Each layer may contain a region of any rectangular size.

The multi-layer encoded video is stored, buffered, or transmitted in appropriate hardware. It is sent in real time or later from storage to a client through a link 316 such as a network or Internet connection. At the client end 314, a position selector 338 considers the position of the head mounted display or any other input or combination of inputs to select a region-of-interest (ROI) for display. The region of interest is typically selected using an inertial measurement unit (IMU) that is attached to a head mounted display (HMD). However, the region of interest may be selected by the user using gestures, a controller, or other devices.

The selected region-of-interest is sent to a layer selector 344 and also to an ROI extractor 334. The ROI is used by the layer selector to determine which layers of the bitstream are to be decoded in order to reconstruct the selected region of interest. The layer selector is not shown as being a part of the client. It may be at the client end 314, the server end 312, or at some other network location.

The described approach may be used in a variety of different scenarios. In a downloading scenario, a pre-encoded bitstream is downloaded. In this case the full bitstream containing all layers is downloaded, and the layer selection occurs at the client. In a streaming scenario, the layer selection can occur at the server, based on feedback from the user about the head mounted display position. In this case network bandwidth can be saved by transmitting at a given time only those layers which will be decoded. In HEVC and its SHVC extension, the layer ID (Identification) of each packet of the compressed video bitstream is present in a NAL (Network Abstraction Layer) unit header, so it is straightforward for the layer selector to examine the header and determine if the packet belongs to a selected layer. Other encoding systems may use other systems to identify and sort different layers.

The selected layers or all of the layers, depending on the implementation, are provided to a Multi-Layer Video Decoder 332 at the client 314. The selected layers are then decoded at the client using the decoder. When inter-layer prediction is used, the selected layers include the base layer and at least one enhancement layer representing a region of the panoramic frame. Other layers representing other information or details may also be decoded. When inter-layer prediction is not used, the base layer isn't needed, and the selected layers include at least one enhancement layer. The decoded layers are sent to a Region Combiner and ROI Extractor 334. In some cases, the region-of-interest will fit within a single region, so only one enhancement layer is decoded, in addition to the base layer, when needed, to show the full view on the display. However, if the region-of-interest is not fully contained within a single region, more than one enhancement layer is selected for decoding, and the overlapping regions are combined in the combiner. Since the combiner is coupled to the position sensor it is able to combine the layers so that the selected ROI is prominent in the display 336. The overlapped areas in the overlapping regions can be combined, i.e. by averaging together the decoded values from the corresponding position of the two layers, or by simply selecting the value from one of the layers. The decoded full resolution region-of-interest is then displayed.

Motion of the head mounted display position by the viewer leads to a change in the instantaneous region-of-interest, which may lead to a change of the overlapping regions and hence the selected layers needed to represent the region of interest. When a new layer is selected for decoding, a random access point, such as an Intra-coded “I” frame, may be needed as a starting point for that layer before that layer can be decoded. HEVC uses a group of pictures approach with I (intra-coded) pictures, P (predictive coded) pictures, and B (bipredictive coded or base) pictures or frames. The I frame is independently coded and is typically required as the first frame to decode a sequence. The P and B frames contain modifications of the I frame.

For example, consider a three layer scalable coding sequence, with a base layer and two enhancement layers, where the base layer and enhancement layers contain I frames at frame num 0, and the enhancement layers also contain I frames at frame number 3. The I frame in each enhancement layer is scalably coded, dependent on the corresponding base layer frame. If a system initially decodes only the base layer and enhancement layer 1, and desires to start also decoding enhancement layer 2 at frame number 1, enhancement layer 2 frames 1 and 2 cannot be decoded, and the system must wait until frame number 3 where the I frame is present in enhancement layer 2. This is shown in the sequence below:

| Enhan2 | I | P | P | I | P |
|---|---|---|---|---|---|
| Enhan1 | I | P | P | I | P |
| Base | I | P | P | P | P |
| FrameNum | 0 | 1 | 2 | 3 | 4 |

In the approach described herein, random access points such as I frames are used more frequently in the enhancement layers than in the base layer. While I frames require many more bits than P (Predictive) or B (Base) frames, enhancement layer I frames are not as expensive to code as non-scalable I frames because they are predicted from the base layer frame.

Using this approach, when a viewer's head mounted display position changes enough that a new layer is selected for decoding, the system waits until a random access point is available in the new enhancement layer. Prior to that point, a lower resolution version of the region-of-interest can be displayed, by using just an upsampled version of the decoded base layer for that area of the frame. Once the random access point is available in the newly selected enhancement layer, the full resolution decoded region-of-interest can be displayed. If the duration of the low resolution playback is minimal, this switching of resolution will not be too visually objectionable. This is particularly true if the switching occurs during periods of fast motion. For typical video frame rates of 24, 30 or more frames per second, using 3 or even more frames to provide full resolution after a switch will not be noticeable.

More sophisticated layer selectors may be used to anticipate the need to switch to another region of interest and corresponding layer based on tracking the headset motion and predicting the path of motion. The decoder may then proactively start selecting a new layer based on the predicted motion before the new layer is needed. This will allow time for a random access point frame, such as an I frame, to arrive before the region corresponding to the new layer is to be displayed. While the processing demands on the decoder are increased, there is still less to decode than if the full panoramic frame were being decoded with every frame.

Using overlapping regions rather than non-overlapping regions increases the likelihood that the region-of-interest will fit within a single region, which reduces the resources required for decoding. Overlapping regions minimize the need to switch between regions. This reduces the time during which lower resolution video is displayed when the viewer moves head position rapidly.

The existing SHVC syntax provides a mechanism to indicate scaled reference layer offsets and reference region offsets in the picture parameter set (PPS), which can be used to indicate the relative size and positions of the regions coded with each layer. The SHVC syntax allows the flexibility to change those parameters on a per frame basis. While it is not necessary to change the regions of the frame associated with each layer, this may be done with major scene changes. The techniques described herein typically use the same region sizes and positions for all of the frames in a coded video sequence. This consistency simplifies the layer selection and region combining functions. The reduced flexibility allows the client end implementation and layer selector to be simplified by designing these for constant and fixed region sizes and positions.

The described techniques may be facilitated in SVHC by providing additional syntax in the sequence parameter set or in the video parameter set extensions or in other high layer syntax of HEVC, or in a systems layer, to indicate the parameters used for the selective region decoding. These parameters may include the number of layers, the number of regions of interest, the size of the region for each layer, the position of the region for each layer, such as an offset, and the downsampling ratio used for the base layer. Additional parameters may be defined as well. Alternatively, sets of parameters may be indicated by a single code, such as code 3 for the configuration of FIG. 3 and code 4 for the configuration of FIG. 4.

Both the encoder/server and decoder/display ends of the system may be adapted to work together. To this end, the particular adaptation may be defined in a specification to allow different products to work together. The adoption of the specification may be indicated in product literature or by marking.

Any of a variety of different virtual reality video systems may use the described system. The system may be used both for content creation at the server end as well as for content consumption with a head mounted display or other immersive system at the client end. The client systems may include wearables such as head mounted displays as well as larger fixed installations. The receivers and decoders may be implemented in PCs and phones which provide compute and graphics capabilities. The described system reduces the computational load of a high resolution omnidirectional multimedia application framework.

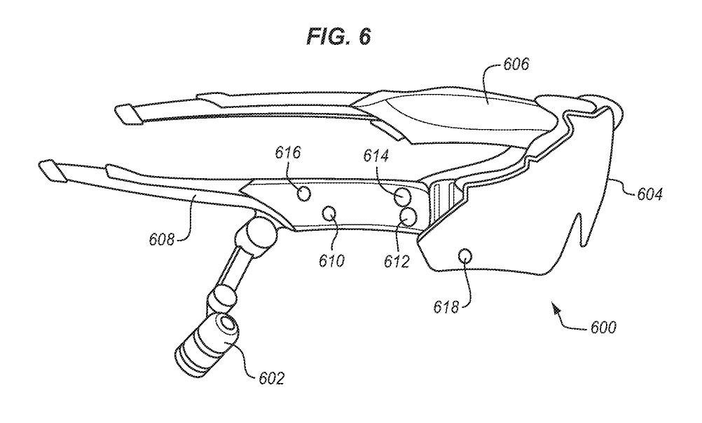

FIG. 6 is an isometric view of a wearable device with display, and wireless communication as described above. This diagram shows a communication glasses device 600 with an opaque display that completely fills the user's view for virtual reality purposes. Alternatively, a transparent, semi-transparent, or opaque front display may be used for informational displays or augmented reality. However the head-mounted display 600 may be adapted to many other wearable, handheld, and fixed devices.

The communication glasses have a single full-width lens 604 to protect the user's eyes and to serve as a binocular or stereo vision display. The lens serves as a frame including a bridge and nosepiece between the lenses, although a separate frame and nosepiece may be used to support the lens or lenses. The frame is attached to a right 606 and a left temple 608. An earbud 602 and a microphone 610 are attached to the right temple. An additional earbud, microphone or both may be attached to the other temple to provide positional information. In this example, the communication glasses are configured to be used for augmented reality applications, however, a virtual reality version of the head-mounted display may be configured with the same form factor using gaskets around the lens to seal out ambient light. A head strap (not shown) may be attached to the temples to wrap around a user's head and further secure the display 600.

The communication glasses are configured with one or more integrated radios 612 for communication with cellular or other types of wide area communication networks with a tethered computer or both. The communications glasses may include position sensors and inertial sensors 614 for navigation and motion inputs. Navigation, video recording, enhanced vision, and other types of functions may be provided with or without a connection to remote servers or users through wide area communication networks. The communication glasses may also or alternately have a wired connection (not shown) to a tethered computer as described above.

In another embodiment, the communication glasses act as an accessory for a nearby wireless device, such as a tethered computer or server system connected through the radios 612. The user may also carry a smart phone or other communications terminal, such as a backpack computer, for which the communications glasses operate as a wireless headset. The communication glasses may also provide additional functions to the smart phone such as voice command, wireless display, camera, etc. These functions may be performed using a personal area network technology such as Bluetooth or Wi-Fi through the radios 612. In another embodiment, the communications glasses operate for short range voice communications with other nearby users and may also provide other functions for navigation, communications, or virtual reality.

The display glasses include an internal processor 616 and power supply such as a battery. The processor may communicate with a local smart device, such as a smart phone or tethered computer or with a remote service or both through the connected radios 612. The display 604 receives video from the processor which is either generated by the processor or by another source tethered through the radios 612. The microphones, earbuds, and IMU are similarly coupled to the processor. The processor may include or be coupled to a graphics processor, and a memory to store received scene models and textures and rendered frames. The processor may generate graphics, such as alerts, maps, biometrics, and other data to display on the lens, optionally through the graphics processor and a projector.

The display may also include an eye tracker 618 to track one or both of the eyes of the user wearing the display. The eye tracker provides eye position data to the processor 616 which provides user interface or command information to the tethered computer.

The FIG. 6 device is just one example of a virtual reality headset that may be used as a client device. It includes a display attached to a head strap and earphones. There are also microphone and inertial sensors to determine when a user is moving and a direction in which the user is looking. There may also be other user input devices connected wirelessly or wired to the headset. The graphics processing including the decoding described herein may be performed by the device or by a connected computer.

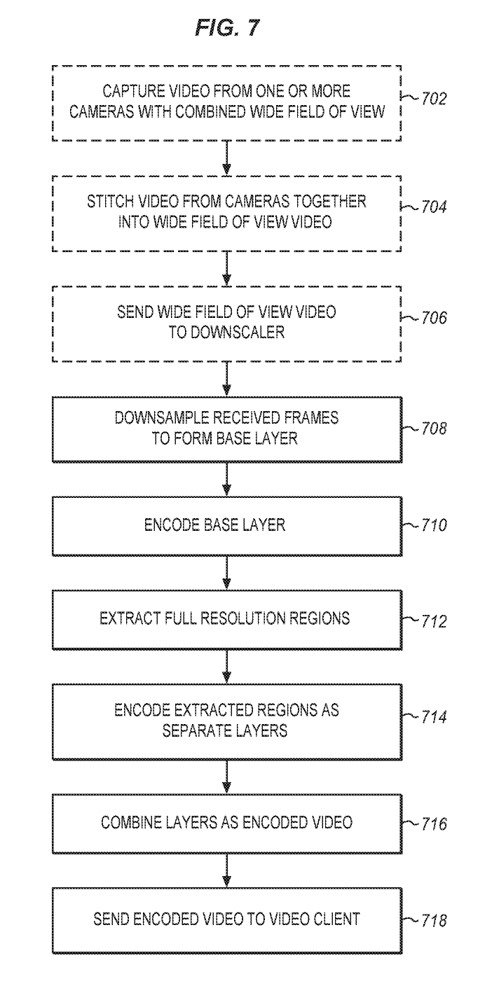

FIG. 7 is a process flow diagram for a method that might be performed on the server side or on a tethered computer including the server side 312 described above. The system includes or is coupled to a camera system with one or more cameras to capture a wide field of view video. At 702 video is captured by the one or more cameras to provide a combined wide field of view video. The wide field of view may be 360 video, panoramic video or any other wide field that is wider than will be presented to the user. The captured video is then stitch together at 704 from the cameras into the ide field of view video. At 706 the video is then sent to a downscaler and to a region extractor of an encoding system.

At 708 the downscaler downsamples the received frames to form a smaller, lower resolution video file. At 710 this downsampled version of the full video is encoded as a base layer or layer 0 for the encoded video.

At 712 full resolution regions are extracted from the full combined video. These may be extracted simply by cropping frames of the full video to form multiple overlapping pieces of each frame. At 714 the extracted regions are encoded each as a separate layer of the video. A multi-layer video encoder encodes these layers and may also encode additional layers to show more detail. The enhanced layers may also be sent to a client to include with any decoding. Reference layer offsets may be used to indicate the relative position of a respective region with respect to the scaled base layer as in SHVC multi-layer video. At 716 these layers are all combined to form an encoded video. At 718 encoded video is sent to a video client or stored for later use. The client will then display some or all of the encoded video depending on commands received from the user.

The video may be sent through a wireless network connection, a cellular connection or through wired or tethered connection. The video is received at a client in full or in part. The decoding will use the layers so that only a region of interest is decoded. As described above, the region of interest may also be used to reduce the data that is sent through the connection.

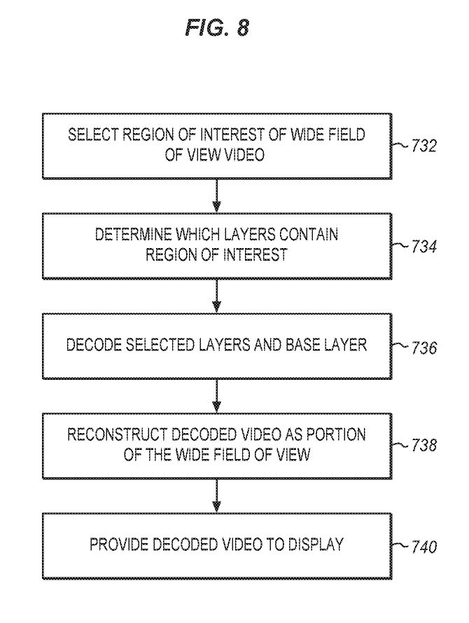

FIG. 8 is a process flow diagram of decoding the video using regions of interest and the unique encoding system described herein. The encoded video may be downloaded from a server system, retrieved from local storage, or streamed from a local or remote source.

At 732 a region of interest of the wide field of view video is selected. For a VR headset, the display is part of a head-mounted display and a region of interest is selected by determining an orientation of a head mounted display. Alternatively, the region may be selected using hand gestures, a controller, an eye tracker or in other ways. In some cases, in order to reduce latency, the region of interest may be predicted using previous movements. This allows the next region of interest to be selected and decoded before it is required. At 734 the layers of the encoded video that contain the region of interest are determined. This may be done local to the display or, as mentioned above, the region of interest selection may be sent to the remote source which then sends only the layers of the encoded video that are useful for the region of interest. The determination of layers from the selected region may be made at the local display or at the remote source.

The region of interest may be completely within a single layer. More likely, the region of interest is encoded in two or three of the layers. This will depend on the size of the region encoded each layer and the size of the region of interest. Accordingly one, two, three or more layers may be selected.

At 736 the selected layers, which may also include the base layer, are decoded locally and at 738 these layers are used to reconstruct the decoded video as a portion of the original wide field of view video. The reconstruction may be done in different ways depending on how the video is encoded. In some cases, the layers are combined in a way that makes the selected region of interest prominent in the display. The regions may be combined by averaging the overlapping areas, selecting one region over the other for the overlapping area or in other ways. At 740 this portion of the video is provided as decoded video to the display.

The resulting decoded video does not include the entire wide field of view but only the parts that are useful to the display. This is primarily the part that is shown on the display, plus the neighboring areas in the selected layers. The rest of the video is not decoded and may also not be transmitted. For a panoramic video, the decoded video may be one-third or less of the total video, resulting in a corresponding reduction in processing to render the encoded video.

As the use of the client side equipment, there may be a determination of a change in the orientation of the head mounted display or another type of change in the region of interest. The new region of interest is determined and new layers of the encoded video are encoded. The new layers are decoded instead of the previous layers to decode a different portion of the wide field of view. In some cases, there is not enough information about the new layers, either because they have not yet been received or because there is no random access point available from which to fully decode the new layers. In such a case, the base layer is decoded and as the decoded video without the selected layers until a random access point is available in the selected layers.

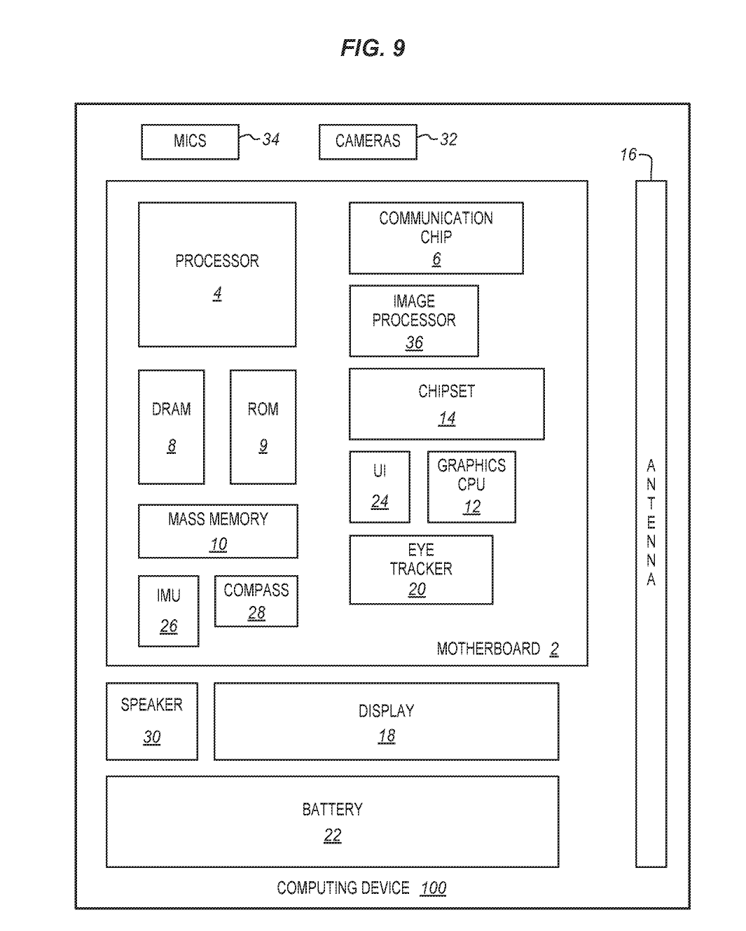

FIG. 9 is a block diagram of a computing device 100 in accordance with one implementation suitable for use as a wearable display or as a tethered computer. The computing device may correspond to the headset of FIG. 6, a supporting computing, other client side equipment or server side equipment. The computing device 100 houses a system board 2. The board 2 may include a number of components, including but not limited to a processor 4 and at least one communication package 6. The communication package is coupled to one or more antennas 16. The processor 4 is physically and electrically coupled to the board 2 and may also be coupled to a graphics processor 36.

Depending on its applications, computing device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18, an eye tracker 20, a battery 22, an audio codec (not shown), a video codec (not shown), a user interface, such as a gamepad, a touchscreen controller or keys 24, an IMU, such as an accelerometer and gyroscope 26, a compass 28, a speaker 30, cameras 32, an image signal processor 36, a microphone array 34, and a mass storage device (such as hard disk drive) 10, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the computing device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The display may be mounted in housings as described above that include straps or other attachment devices to make the display wearable. There may be multiple housings and different processing and user input resources in different housing, depending on the implementation. The display may be placed in a separate housing together with other selected components such as microphones, speakers, cameras, inertial sensors and other devices that is connected by wires or wirelessly with the other components of the computing system. The separate component may be in the form of a wearable device or a portable device.

In various implementations, the computing device 100 may be eyewear, a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device 100 may be any other electronic device that processes data.

Embodiments may be implemented as a part of one or more memory chips, controllers, CPUs (Central Processing Unit), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. The various features of the different embodiments may be variously combined with some features included and others excluded to suit a variety of different applications.

Examples may include a server side apparatus or an encoding system that receives video from one or more cameras with a combined wide or large field of view at a video stitching module to be stitched together into wide field video frames, sending the stitched frames to a video downscaler where it is downsampled to form a base layer of the panoramic video, sending the base layer to a scalable multi-layer video encoder and coded as the base layer, which may be referred to as layer 0, sending the frames also to a region extractor to extract full resolution regions from the frames and encode the regions in the encoder as separate layers.

Further examples are as follows:

The example above in which the regions are the same size.

The examples above in which the layers in the format of SHVC multi-layer video.

The examples above in which the layers are encoded using inter-layer prediction from the base layer.

The examples above in which the layers are encoded using reference layer offsets to indicate the relative position of the region with respect to the scaled base layer.

The examples above in which there are additional layers to provide enhanced details relative to the captured video.

The examples above in which the multi-layer encoded video is stored, buffered, or transmitted in appropriate hardware and it is sent in real time or later from storage to a client.

Examples may also include a client side or user that includes a position selector to consider the position of a head mounted display or any other input or combination of inputs to select a region-of-interest (ROI) for display and to send the selected ROI to a layer selector and also to an ROI extractor, a layer selector to determine which layers of a received encoded video, for example in the form of a bitstream, are to be decoded in order to reconstruct the selected region of interest and a decoder to decode only the layers selected by the layer selector and the base layer.

The example above in which the decoded layers are sent to a Region Combiner and ROI Extractor to combine the layers so that the selected ROI is prominent in the display in response to a position sensor or other input.

The examples above in which the region-of-interest is not fully contained within a single region and more than one enhancement layer is selected for decoding, and the overlapping regions are combined in the combiner.

The examples above in which overlapped areas in the overlapping regions are combined by averaging together the decoded values from the corresponding position of the two layers, or by selecting the value from one of the layers.

The examples above in which the decoded full resolution region-of-interest is displayed on a virtual reality headset.

The examples above in which the video is transmitted to the client side and in which only the regions selected by the layer selector and the base layer are transmitted.

The examples above in which the layer selector is not part of the client, but at the server end or at some other network location.

The examples above in which, random access points such as I frames are used more frequently in the enhancement layers than in the base layer, so that a new layer may be rendered more quickly in response to a change in the ROI.

The examples above in which the need to switch to another region of interest is anticipated and the corresponding layer based on tracking the headset motion and predicting the path of motion is decoded proactively before the new ROI is selected.

Some embodiments pertain an apparatus that includes a buffer to receive a wide field of view video, a region extractor to extract regions from the wide field of view video, and a scalable multi-layer video encoder to encode the extracted regions as separate layers and to combine the layers to form an encoded video.

Further embodiments include a plurality of cameras to each generate a video, a video stitching module coupled to the video downscaler, and the multi-layer encoder to stitch the video from each of the cameras together into frames of the wide field video.

In further embodiments the regions are the same size.

In further embodiments the regions overlap.

In further embodiments the layers are in a format of SHVC multi-layer video.

Further embodiments include a video downscaler to downsample the wide field of view video, wherein the multi-layer encoder encodes the downsampled video as a base layer of the encoded video and wherein the separate layers are encoded as full resolution layers over the base layer.

In further embodiments the multi-layer encoder encodes the layers using inter-layer prediction from the base layer.

In further embodiments the multi-layer encoder encodes the layers using reference layer offsets to indicate the relative position of a respective region with respect to the scaled base layer.

In further embodiments the multi-layer encoder generates additional layers to provide enhanced details relative to the wide field of view video.

Further embodiments include a mass memory to store the encoded video for later transmission to a video client.

Some embodiments pertain to a method that includes receiving a wide field of view video having a sequence of frames at a downscaler, downsampling the received frames to form a base layer of the wide field of view video, encoding the base layer at a multi-layer video encoder, extracting full resolution regions of the frames from the frames at a regions extractor, encoding the extracted regions as separate layers in the video encoder, combining the layers as an encoded video, and sending the encoded video to a video client.

Further embodiments include receiving video from one or more cameras with a combined field of view at a video stitching module, stitching the video from the one or more cameras together into a combined wide field of view video, and sending the wide field of view video to the downscaler.

In further embodiments the base layer is layer 0 and the multiple encoded layers are layers 1, 2, and 3, respectively.

Some embodiments pertain to an apparatus that includes a position selector to select a position in a wide field of view video frame, a layer selector coupled to the position selector to receive the selected position, to determine a corresponding region of interest, and to select one of a plurality of layers of a received encoded video to be decoded in order to reconstruct the selected region of interest, a decoder coupled to the layer selector to decode only the selected layer of the encoded video to form a decoded video, and a display to present the decoded video.

In further embodiments the selected layer uses inter-layer prediction and the decoder decodes the selected layer using a base layer of the encoded video to form the decoded video.

Further embodiments include a combiner to receive the decoded selected layer and base layer and to combine the layers to form a decoded video so that the selected region of interest is prominent in the display in response to the position selector.

In further embodiments the selected position corresponds to two layers of the encoded video, wherein the layer selector selects more than one enhancement layer for decoding, and wherein the combiner combines the more than one enhancement layer to form the decoded video.

In further embodiments the two layers include overlapped areas of the video frames and wherein the overlapped areas are combined in the combiner by selecting decode values from a corresponding position of one of the two layers.

Further embodiments include a communication interface to transmit the decoded video to the display so that only the determined region of interest is transmitted.

In further embodiments the position selector predicts a change to a new position and wherein the corresponding layer based on predicting is decoded before a position change occurs.

Some embodiments pertain to a method that includes selecting a region of interest of a wide field of view video for a display, determining which layers of a plurality of layers of a received encoded video contain the selected region of interest, decoding the selected layers and a base layer in order to reconstruct a decoded video as a portion of the wide field of view video containing the region of interest, and providing the decoded video to the display.

In further embodiments the display is part of a head-mounted display and wherein selecting a region of interest comprises determining an orientation of a head mounted display.

Further embodiments include determining a change in the orientation of the head mounted display, selecting a change in the region of interest and the determined layers of the encoded video, and decoding the base layer as the decoded video without the selected layers until a random access point is available in the selected layers.

What is claimed is:

1. An apparatus comprising:
a buffer to receive a wide field of view video;
a region extractor to extract regions from the wide field of view video; and
a scalable multi-layer video encoder to encode the extracted regions as separate layers and to combine the layers to form an encoded video.

2. The apparatus of claim 1, further comprising:
a plurality of cameras to each generate a video;
a video stitching module coupled to the video downscaler and the multi-layer encoder to stitch the video from each of the cameras together into frames of the wide field video.

3. The apparatus of claim 1, wherein the regions are the same size.

4. The apparatus of claim 1, wherein the regions overlap.

5. The apparatus of claim 1, wherein the layers are in a format of SHVC multi-layer video.

6. The apparatus of claim 1, further comprising a video downscaler to downsample the wide field of view video, wherein the multi-layer encoder encodes the downsampled video as a base layer of the encoded video and wherein the separate layers are encoded as full resolution layers over the base layer.

7. The apparatus of claim 6, wherein the multi-layer encoder encodes the layers using inter-layer prediction from the base layer.

8. The apparatus of claim 6, wherein the multi-layer encoder encodes the layers using reference layer offsets to indicate the relative position of a respective region with respect to the scaled base layer.

9. The apparatus of claim 1, wherein the multi-layer encoder generates additional layers to provide enhanced details relative to the wide field of view video.

10. The apparatus of claim 1, further comprising a mass memory to store the encoded video for later transmission to a video client.

11. A method comprising:
receiving a wide field of view video having a sequence of frames at a downscaler;
downsampling the received frames to form a base layer of the wide field of view video;
encoding the base layer at a multi-layer video encoder;
extracting full resolution regions of the frames from the frames at a regions extractor;
encoding the extracted regions as separate layers in the video encoder;
combining the layers as an encoded video; and
sending the encoded video to a video client.

12. The method of claim 11, further comprising:
receiving video from one or more cameras with a combined field of view at a video stitching module;
stitching the video from the one or more cameras together into a combined wide field of view video; and
sending the wide field of view video to the downscaler.

13. The method of claim 11, wherein the base layer is layer 0 and the multiple encoded layers are layers 1, 2, and 3, respectively.

14. An apparatus comprising:
a position selector to select a position in a wide field of view video frame;
a layer selector coupled to the position selector to receive the selected position, to determine a corresponding region of interest, and to select one of a plurality of layers of a received encoded video to be decoded in order to reconstruct the selected region of interest;
a decoder coupled to the layer selector to decode only the selected layer of the encoded video to form a decoded video; and
a display to present the decoded video.

15. The apparatus of claim 14, wherein the selected layer uses inter-layer prediction and the decoder decodes the selected layer using a base layer of the encoded video to form the decoded video.

16. The apparatus of claim 15, further comprising a combiner to receive the decoded selected layer and base layer and to combine the layers to form a decoded video so that the selected region of interest is prominent in the display in response to the position selector.

17. The apparatus of claim 14, wherein the selected position corresponds to two layers of the encoded video, wherein the layer selector selects more than one enhancement layer for decoding, and wherein the combiner combines the more than one enhancement layer to form the decoded video.

18. The apparatus of claim 17, wherein the two layers include overlapped areas of the video frames and wherein the overlapped areas are combined in the combiner by selecting decode values from a corresponding position of one of the two layers.

19. The apparatus of claim 14, further comprising a communication interface to transmit the decoded video to the display so that only the determined region of interest is transmitted.

20. The apparatus of claim 14, wherein the position selector predicts a change to a new position and wherein the corresponding layer based on predicting is decoded before a position change occurs.

21. A method comprising:
selecting a region of interest of a wide field of view video for a display;
determining which layers of a plurality of layers of a received encoded video contain the selected region of interest;
decoding the selected layers and a base layer in order to reconstruct a decoded video as a portion of the wide field of view video containing the region of interest; and
providing the decoded video to the display.

22. The method of claim 21, wherein the display is part of a head-mounted display and wherein selecting a region of interest comprises determining an orientation of a head mounted display.

23. The method of claim 22, further comprising:
determining a change in the orientation of the head mounted display;
selecting a change in the region of interest and the determined layers of the encoded video; and
decoding the base layer as the decoded video without the selected layers until a random access point is available in the selected layers.
